(19) United States
(12) Patent Application Publication
(10) Pub. No.: US 2016/0066369 A1
(43) Pub. Date: Mar. 3, 2016

(54) COOKING APPLIANCE

(71) Applicant: Miele & Cie. KG, Guetersloh (DE)

(72) Inventors: Christian Schulze, Enger (DE); Andre Peters, Herford (DE); Ruediger Hoehn, Hiddenhausen (DE); Carolin Kaudewitz, Rheda-Wiedenbrueck (DE)

(21) Appl. No.: 14/836,992

(22) Filed: Aug. 27, 2015

(30) Foreign Application Priority Data
Sep. 1, 2014 (DE) 10 2014 112 522.3

(51) Int. Cl. H05B 6/64

(52) U.S. Cl. CPC H05B 6/6479; H05B 6/6414; H05B 6/6444

(57) ABSTRACT

A cooking appliance includes at least one cooking chamber, at least one steam generation device that supplies the at least one cooking chamber with steam, at least one microwave device assigned to the at least one cooking chamber that heats food, the at least one microwave device having at least one microwave generator that introduces microwave radiation into the at least one cooking chamber at at least one input portion, at least one illumination device provided on the at least one input portion, and at least one sealing device assigned to the at least one input portion, the at least one sealing device being substantially transparent at least in portions. The at least one sealing device seals the at least one input portion with respect to the at least one cooking chamber in a substantially steam-tight manner.

### CROSS-REFERENCE TO PRIOR APPLICATION

Priority is claimed to German Patent Application No. DE 10 2014 112 522.3, filed on Sep. 1, 2014, the entire disclosure of which is hereby incorporated by reference herein.

### FIELD

The present invention relates to a cooking appliance comprising at least one cooking chamber, at least one steam generation device and at least one microwave device being assigned to the cooking chamber in order to heat food. In this case, the steam generation device is capable of and designed to supply the cooking chamber with steam. The microwave device comprises at least one microwave generator which introduces microwave radiation into the cooking chamber at at least one input portion. Furthermore, at least one illumination device is provided.

### BACKGROUND

In cooking appliances having a microwave function, the microwaves are generally first introduced into a wave channel adjoining the cooking chamber, from where they enter the cooking chamber. The point at which the microwaves enter the cooking chamber is then usually covered by a mica sheet. In some cooking appliances, however, the microwaves also enter the cooking chamber without the provision of a specific wave channel cover.

In addition, a means of illumination is also often provided for the cooking chamber of a cooking appliance and usually lights up the cooking chamber through a recess provided therefor in a cooking chamber wall.

However, if the cooking appliance is designed as a combination cooking appliance, in which, in addition to the microwave function, it is also possible to heat the cooking chamber by means of steam, the above-described designs have potential disadvantages.

In a combination cooking appliance of this type, the cooking chamber should namely be as steam-tight as possible and should not leak with respect to the appliance interior either, in particular even when there is a large amount of steam in the cooking chamber. Otherwise, in the worst possible case, steam could enter the appliance interior from the cooking chamber and damage technical components. Even in the above-described designs, however, there are two points prone to potential leaks.

### SUMMARY

A cooking appliance includes at least one cooking chamber, at least one steam generation device that supplies the at least one cooking chamber with steam, at least one microwave device assigned to the at least one cooking chamber that heats food, the at least one microwave device having at least one microwave generator that introduces microwave radiation into the at least one cooking chamber at at least one input portion, at least one illumination device provided on the at least one input portion, and at least one sealing device assigned to the at least one input portion, the at least one sealing device being substantially transparent at least in portions. The at least one sealing device seals the at least one input portion with respect to the at least one cooking chamber in a substantially steam-tight manner.

### BRIEF DESCRIPTION OF THE DRAWINGS

The present invention will be described in even greater detail below based on the exemplary figures. The invention is not limited to the exemplary embodiments. Other features and advantages of various embodiments of the present invention will become apparent by reading the following detailed description with reference to the attached drawings which illustrate the following:

FIG. 1 is a purely schematic perspective view of a cooking appliance according to the invention;

FIG. 2 is a purely schematic sectional view of a cooking appliance according to the invention in the region of the input portion;

FIG. 3 is an enlarged view of the region marked in FIG. 2; and

FIG. 4 is a purely schematic plan view of a sealing device.

### DETAILED DESCRIPTION

The cooking appliance according to the invention comprises at least one cooking chamber, at least one steam generation device and at least one microwave device being assigned to the cooking chamber in order to heat food. In this case, the steam generation device is capable of and designed to supply the cooking chamber with steam. The microwave device comprises at least one microwave generator which introduces microwave radiation into the cooking chamber at at least one input portion. Furthermore, at least one illumination device is provided on the input portion. In addition, at least one sealing device is assigned to the input portion and is substantially transparent at least in portions. The sealing device is furthermore capable of and designed to seal the input portion with respect to the cooking chamber in a substantially steam-tight manner.

According to the invention, “substantially transparent” in particular means that the sealing device is either largely or even completely transparent over a significant portion. It may also advantageously be transparent in parts. In this case, “in parts” preferably means that at least portions of the sealing device are transparent or translucent. At least portions of the sealing device can advantageously also be completely translucent. However, it is also possible for the sealing device to not be completely transparent and to have a scattering effect, such as milk glass.

According to the invention, “substantially steam-tight” in particular means that the sealing device is substantially completely steam-tight and reliably seals the cooking chamber with respect to the input portion, even in the event of a steam content of from 95 to 98 vol. %, preferably of 100 vol. %.

The cooking appliance according to the invention has many advantages. A significant advantage is that the specific design of the input portion together with the sealing device provided at that point provides a cooking appliance in which food can be cooked using steam and/or microwaves in an unrestricted manner. The portion for inputting microwave radiation is reliably sealed against the steam in the cooking chamber as a result of the specific design of the sealing device. Since the illumination device is also provided in the input portion, it is further possible to optimally illuminate the cooking chamber, wherein the illumination device is also sealed with respect to the cooking chamber in a substantially steam-tight manner. In this case, the cooking chamber is illuminated in particular by the sealing device being transparent both substantially and at least in portions.

The input portion preferably comprises at least one wave channel. The microwave radiation is introduced into this wave channel by the microwave generator, and it passes from here into the cooking chamber.

The input portion particularly preferably has at least one portion for receiving the illumination device. This receiving portion is in particular formed as a mounting portion for at least one illumination device or for receiving a light element of the illumination device. In this case, a passage into the housing interior, through which a light element can be inserted into the input portion, can in particular be provided.

In advantageous developments, the receiving portion for the illumination device is joined to the wave channel towards the cooking chamber. As a result, the receiving portion for the illumination device preferably directly adjoins the cooking chamber, resulting in optimal illumination of the cooking chamber by the illumination device.

It is further preferred for the illumination device to be provided at the receiving portion outside the cross section of the wave channel. It can thus be ensured that there is a free wave channel cross section for the introduction of microwave radiation. Furthermore, in this type of design the illumination device is provided outside the wave channel so as to not be constantly exposed to high levels of microwave radiation or to not adversely deflect microwave radiation.

The receiving portion preferably comprises at least one through-hole for receiving the illumination device. A hole of this type can preferably have a diameter of between 5 mm and 10 mm, particularly preferably 7 mm. In this case, the through-hole is provided in particular so that an illuminant or an illumination element of the illumination device can be inserted into the receiving portion through the through-hole. As a result, most of the technical components of the illumination device inside the housing can be provided in the input portion in a manner protected from microwave radiation. Only the illumination element is passed through the through-opening or introduced into the through-opening in the receiving portion of the input portion in order to illuminate the cooking chamber.

At least portions of the sealing device are particularly preferably made of a material which has a low coefficient of expansion. This ensures that no leakages occur as a result of excessive expansion of the sealing device, even during heating or subsequent cooling of the sealing device.

In advantageous developments, at least portions of the sealing device are made of a pressed glass. A pressed glass of this type has properties which are particularly advantageous for the use according to the invention.

At least portions of the sealing device are then preferably made of borosilicate glass. Here too an embodiment made of borosilicate pressed glass is particularly preferred. In this case, such a sealing device made of borosilicate glass has properties which are advantageous for the intended use. Borosilicate glass is in particular sufficiently transparent for light from the illumination device to enter the cooking chamber. Furthermore, microwave radiation can pass through borosilicate glass and said glass is additionally suitable as a substantially steam-tight seal for the input portion. In particular, borosilicate glass is thus particularly suitable owing to its very low coefficient of expansion.

The sealing device is preferably retained on the input portion and in particular on the receiving portion by means of a substantially steam-tight attachment device. As a result, a substantially steam-tight barrier is also created between the input portion and the cooking chamber at the region where the sealing device is in contact with the input portion.

The attachment device is preferably a steam-tight adhesive and/or a silicone. In this case, transparent two-component silicone can particularly preferably be used in advantageous embodiments. Such an embodiment, in which the sealing device is attached by means of a steam-tight adhesive and/or silicone, ensures a reliable and also permanently steam-tight connection between the sealing device and the input portion.

The sealing device particularly preferably comprises at least one substantially circumferential groove. The attachment device, such as an adhesive or silicone, can preferably be introduced into a circumferential groove of this type. As a result, a particularly reliable steam-tight and permanent connection is ensured. In other expedient embodiments, the groove can also engage in a substantially circumferential tongue or ridge on the input portion. In addition to the attachment device, a very reliable and also permanently steam-tight connection is ensured as a result, wherein the groove and the tongue in particular also allow for the sealing device to be optimally oriented on the input portion.

In preferred developments, the illumination device has at least one LED device. As a result, the cooking chamber can be illuminated in a cost-effective and energy-saving manner for a long period of time.

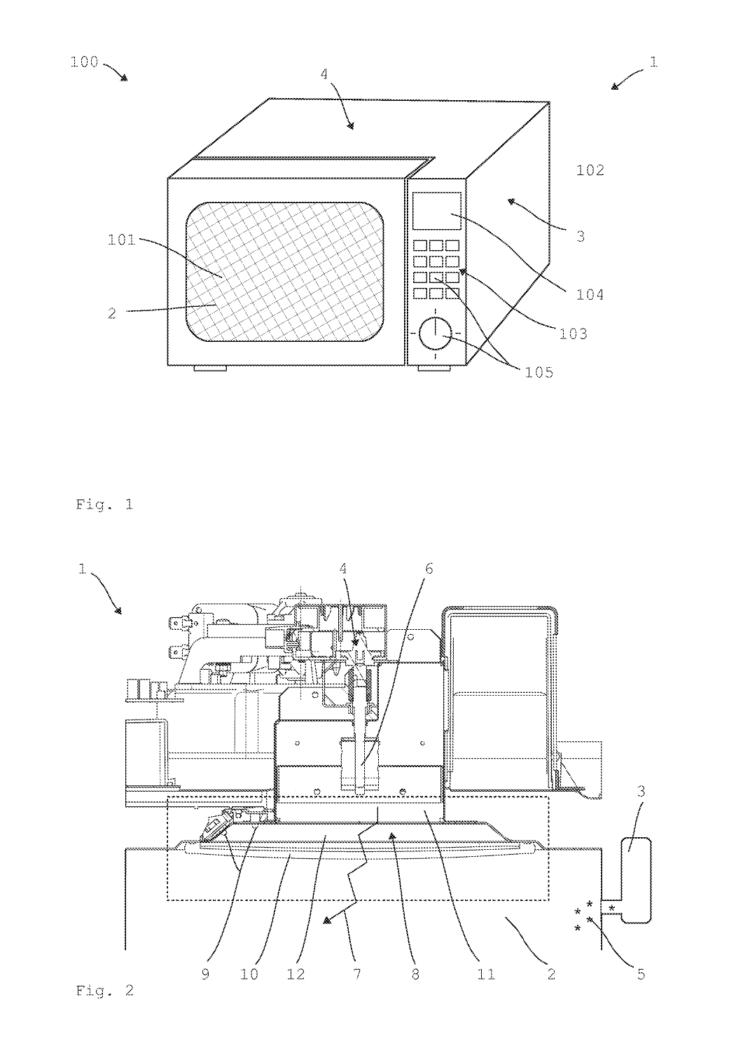

FIG. 1 is a purely schematic perspective view of a cooking appliance 1 according to the invention. The cooking appliance 1 has a cooking chamber 2 in which food can be cooked by means of a steam generation device 3 and/or a microwave device 4. The cooking appliance 1 shown here is therefore in the form of a combination cooking appliance 100. In this case this combination cooking appliance 100 has a cooking chamber door 101 which is substantially microwave-tight and closes the cooking chamber 2.

In this case, the cooking chamber 2 is formed in a housing 102, on which is also provided an operating portion 103 which has both a display device 104 and various operating elements 105 in the embodiment shown here.

FIG. 2 is a purely schematic sectional view of a cooking appliance 1 according to the invention. It can be seen here that the cooking chamber 2 can be heated by a steam generation device 3, wherein steam 5 generated by the steam generation device 3 can be introduced into the cooking chamber. In addition, food can also be cooked by means of microwave radiation 7 which is introduced into the cooking chamber at an input portion 8 by a microwave generator 6 of the microwave device 4.

In the embodiment shown here, the input portion 8 comprises a wave channel 11 and a receiving portion 12 for an illumination device 9. Microwave radiation 7 is introduced into said wave channel 11 by the microwave generator 6 and then enters the cooking chamber 2 via the wave channel 11, passing through the sealing device 10.

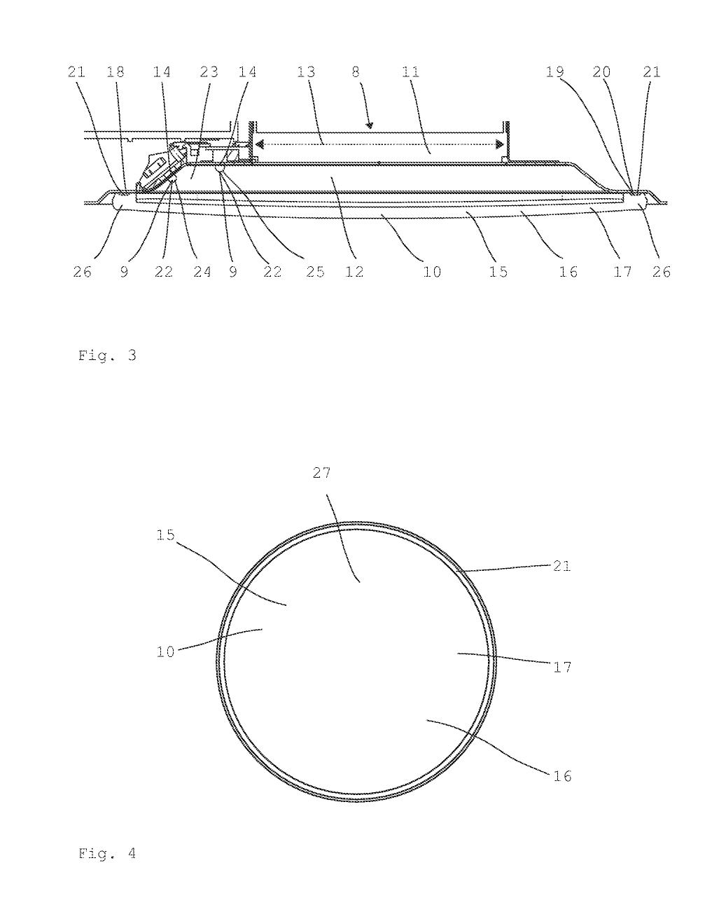

FIG. 3 is a purely schematic magnification of the region marked by a dotted box in FIG. 2. The input portion 8, which, in the embodiment shown, comprises the wave channel 11 and the receiving portion 12 for the illumination devices 9 (two shown in this case), can also be seen here.

So that the cooking chamber is sufficiently and in particular completely sealed with respect to the input portion 8 even in the event of a high steam concentration of from 95 to 98 vol. %, or even 100 vol. % in the cooking chamber, the sealing device 10 is designed to be substantially steam-tight.

In this case, the sealing device 10 consists of a pressed glass 16 which, in this particular embodiment, is in the form of borosilicate glass 17 or borosilicate pressed glass. In general, any steam-tight material in particular having a low coefficient of expansion can preferably and expediently be used for the sealing device 10. This prevents any leakages occurring towards the input portion 8, even in the event of large temperature fluctuations in the cooking chamber, as a result of an expanding or contracting sealing device 10.

In order for the light from the illumination device 9 to be able to pass from the receiving portion 12 into the cooking chamber 2, the sealing device 10 is also designed to be substantially transparent. The borosilicate glass 17 used here also provides this property.

In the embodiment shown here, the illumination device 9 and the technical components thereof are arranged substantially outside the receiving portion 12. However, in this case two through-openings 14 are provided in the metal sheet 23 of the receiving portion 12, through which openings the illumination elements 24 of the illumination device 9 can be introduced into the receiving portion 12. In this case, the illumination elements 24 are formed as LED devices 22, each of which have an LED 25.

So that the illumination devices 9 are not arranged inside the wave channel 11, they are preferably arranged on the receiving portion 12 outside the cross section 13 of the wave channel 11.

In order to attach the sealing device 10 to the input portion 8 or to the receiving portion 12, a substantially steam-tight attachment device 18 is used here. In this case, silicone 20 is provided as the attachment device 18, wherein a steam-tight or watertight adhesive 19 can also be used in other embodiments. By using silicone 20 or two-component silicone to attach the sealing device 10 to the input portion 8, the connecting point between the sealing device 10 and the input portion 8 is also steam-tight. Thus the cooking chamber 2 can be reliably sealed in a steam-tight manner, in particular when there is a high concentration of steam in the cooking chamber 2.

In order to particularly effectively seal the region 26 where the sealing device 10 is attached to the input portion 8, a groove 21 is provided in the attachment portion 26 in the embodiment shown here. The attachment device 18 or the adhesive 19 or the silicone 20 can be introduced into said groove 21. When attaching the sealing device 10 to the input portion 8, a particularly reliable steam-tight connection between the sealing device 10 and the input portion 8 is established as a result.

In other embodiments, a tongue-like shape or a ridge into which the groove 21 in the sealing device 10 can engage can also be provided on the receiving portion 12 or on the input portion 8. A particularly effective and also steam-tight connection which interacts with the silicone 20 is also established as a result, wherein due to the tongue-like shape on the input portion 8, the sealing device 10 can also be both simply and optimally oriented on the input portion 8.

FIG. 4 is a purely schematic plan view of an embodiment of a sealing device 10. In this case, the sealing device 10 is in the form of a substantially round disc 27 made of borosilicate glass 17 or borosilicate pressed glass. The circumferential groove 21 into which the attachment device 18 can be introduced can be seen in the edge region of the disc 27.

In general, the sealing device 10 is substantially transparent so that light from an illumination device 9 can pass through the sealing device 10 and into the cooking chamber. Furthermore, the sealing device is substantially steam-tight and the connection between the sealing device 10 and the input portion 8 is also advantageously designed to be substantially steam-tight. As a result, a cooking appliance 1 is provided which is highly effective in combination mode or can also be operated in individual mode using steam and/or microwave radiation, without steam escaping from the cooking chamber. In addition, the design of the input portion allows the wave channel 11 and the receiving portion 12 for the illumination device 9 to be provided under a common sealing device 10 so that only one seal is required for the cooking chamber here. This simplifies the design of the cooking appliance 1.

While the invention has been illustrated and described in detail in the drawings and foregoing description, such illustration and description are to be considered illustrative or exemplary and not restrictive. It will be understood that changes and modifications may be made by those of ordinary skill within the scope of the following claims. In particular, the present invention covers further embodiments with any combination of features from different embodiments described above and below. Additionally, statements made herein characterizing the invention refer to an embodiment of the invention and not necessarily all embodiments.

The terms used in the claims should be construed to have the broadest reasonable interpretation consistent with the foregoing description. For example, the use of the article “a” or “the” in introducing an element should not be interpreted as being exclusive of a plurality of elements. Likewise, the recitation of “or” should be interpreted as being inclusive, such that the recitation of “A or B” is not exclusive of “A and B,” unless it is clear from the context or the foregoing description that only one of A and B is intended. Further, the recitation of “at least one of A, B and C” should be interpreted as one or more of a group of elements consisting of A, B and C, and should not be interpreted as requiring at least one of each of the listed elements A, B and C, regardless of whether A, B and C are related as categories or otherwise. Moreover, the recitation of “A, B and/or C” or “at least one of A, B or C” should be interpreted as including any singular entity from the listed elements, e.g., A, any subset from the listed elements, e.g., A and B, or the entire list of elements A, B and C.

List of reference numerals

| | |
|---|---|
| 1 | cooking appliance |
| 2 | cooking chamber |
| 3 | steam generation device |
| 4 | microwave device |
| 5 | steam |
| 6 | microwave generator |
| 7 | microwave radiation |
| 8 | input portion |
| 9 | illumination device |
| 10 | sealing device |
| 11 | wave channel |
| 12 | receiving portion |
| 13 | cross section |
| 14 | through-opening |
| 15 | material having a low coefficient of |
| | expansion |
| 16 | pressed glass |
| 17 | borosilicate glass |
| 18 | attachment device |
| 19 | adhesive |
| 20 | silicone |
| 21 | groove |
| 22 | LED device |
| 23 | metal sheet |
| 24 | illumination element |
| 25 | LED |
| 26 | attachment portion |
| 27 | disc |
| 100 | combination cooking appliance |
| 101 | cooking chamber door |
| 102 | housing |
| 103 | operating portion |
| 104 | display device |
| 105 | operating element |

What is claimed is:

1. A cooking appliance, comprising:
at least one cooking chamber;
at least one steam generation device configured to supply the at least one cooking chamber with steam;
at least one microwave device assigned to the at least one cooking chamber and configured to heat food, the at least one microwave device having at least one microwave generator configured to introduce microwave radiation into the at least one cooking chamber at at least one input portion;
at least one illumination device provided on the at least one input portion; and
at least one sealing device assigned to the at least one input portion, the at least one sealing device being substantially transparent at least in portions and configured to seal the at least one input portion with respect to the at least one cooking chamber in a substantially steam-tight manner.

2. The cooking appliance of claim 1, wherein the at least one input portion comprises at least one wave channel.

3. The cooking appliance of claim 1, wherein the at least one input portion comprises at least one receiving portion configured to receive the at least one illumination device.

4. The cooking appliance of claim 3, wherein the at least one receiving portion is joined to at least one wave channel towards the at least one cooking chamber.

5. The cooking appliance of claim 4, wherein the at least one illumination device is provided on the at least one receiving portion outside a cross section of the at least one wave channel.

6. The cooking appliance of claim 3, wherein the at least one receiving portion comprises at least one through-hole configured to receive the at least one illumination device.

7. The cooking appliance of claim 1, wherein at least portions of the at least one sealing device comprise a material that has a low coefficient of expansion.

8. The cooking appliance of claim 1, wherein at least portions of the at least one sealing device comprise pressed glass.

9. The cooking appliance of claim 1, wherein at least portions of the at least one sealing device comprise borosilicate glass.

10. The cooking appliance of claim 1, wherein the at least one sealing device is retained on the at least one input portion.

11. The cooking appliance of claim 11, wherein the at least one sealing device is retained on the at least one input portion on the at least one receiving portion by a substantially steam-tight attachment device.

12. The cooking appliance of claim 11, wherein the substantially steam-tight attachment device comprises at least one of a steam-tight adhesive or a silicone.

13. The cooking appliance of claim 1, wherein the at least one sealing device comprises at least one substantially circumferential groove.

14. The cooking appliance of claim 1, wherein the at least one illumination device comprises at least one LED device.
